(19) United States
(12) Patent Application Publication
(10) Pub. No.: US 2007/0149344 A1
(43) Pub. Date: Jun. 28, 2007

(54) Combination torque conversion and transfer system and method thereof

(75) Inventors: Marc McGrath, Strasburg, OH (US); Jeffrey Hemphill, Copley, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/637,579

(22) Filed: Dec. 12, 2006

Related U.S. Application Data
(60) Provisional application No. 60/753,078, filed on Dec. 22, 2005.

(51) Int. Cl. F16H 3/44

(52) U.S. Cl. 475/280

(57) ABSTRACT

The present invention broadly comprises a combination torque transmission system for a vehicle including a planetary gear set in a rotating housing and a gear set device in a stationary housing. The gear set has an input arranged for connection to a torsional output for an engine. The gear set device has an input connected to an output of the planetary gear set. In some aspects, the at least one gear set device is a planetary transmission such as a Ravigneaux gearset, a Simpson gearset, a plurality of simple gearsets, or a Lepelletier six speed arrangement. The gear set device includes a plurality of gear ratios and the planetary gear set is configured to augment the plurality of gear ratios by adding at least one first gear ratio to the plurality of gear ratios. In some aspects, the planetary gear set is configured to double the number of gear ratios.

### CROSS-REFERENCE TO RELATED APPLICATIONS

This application claims the benefit under 35 U.S.C. §119(e) of U.S. Provisional Application No. 60/753,078 filed Dec. 22, 2005.

### FIELD OF THE INVENTION

The invention relates to improvements in apparatus for transmitting force between a rotary driving unit (such as the engine of a motor vehicle) and a rotary driven unit (such as the variable-speed transmission in the motor vehicle). In particular, the invention relates to a system for expanding the gear ratio for a planetary transmission and including a launch clutch in a rotary housing. Specifically, the invention relates to a simple planetary gear set in a rotating housing interfaced with a planetary gear set in a stationary housing.

### BACKGROUND OF THE INVENTION

Planetary automatic transmissions (PATs) are commonly used at least in part because these transmissions offer very smooth performance and are relatively inexpensive to manufacture. Four speed PATs are particularly prevalent. In general, an engine provides optimal fuel efficiency and power output at a specific rotational speed. Unfortunately, the fuel economy of four speed PATs is reduced due to the restricted ability of the four speed PAT to maintain an engine at the aforementioned optimal speed, due to the limited number of gear ratios available for use with these units. Six speed PATs provide improved fuel economy by providing more gear ratios, which allow the engine to operate closer to the optimal speed. Six speed PATs also provide improved performance through better mechanical advantage while accelerating. Unfortunately, six speed PATs are relatively expensive to manufacture and large investments are needed to convert production operations for four speed PATs to production operations for six speed PATs.

It also is known to use torque converters for launch events for vehicles with PATs. Unfortunately, using the converter for launching increases losses at stall as well as pump losses, since a converter charge flow is required. It has been known to install a launch clutch in the stationary housing for a PAT. Unfortunately, space for the clutch must be made by rearranging the existing components in the PAT or by increasing the size of the stationary housing. Both of the preceding options entail considerable effort and expense. Increasing the size of the housing could have undesirable impacts on the overall design of the drive train for a vehicle. In addition, a launch clutch generates more heat than the clutches used to shift between gears in a PAT. Unfortunately, the “standard” pump for a PAT typically does not have the capacity to provide the extra cooling needed. For example, a launch clutch requires a high flow, low pressure cooling stream, which is the opposite of the cooling circuits in a typical PAT.

Thus, there is a long-felt need to increase the fuel economy and engine performance associated with a PAT. Specifically, there is a long-felt need to increase the fuel economy and engine performance associated with a four-speed PAT and to add frictional launch capabilities to a PAT.

### BRIEF SUMMARY OF THE INVENTION

The present invention broadly comprises a combination torque transmission system for a vehicle including a planetary gear set in a rotating housing and a gear set device in a stationary housing. The gear set has an input arranged for connection to a torsional output for an engine. The gear set device has an input connected to an output of the planetary gear set. In some aspects, the at least one gear set device is a planetary transmission. In some aspects, the planetary transmission is selected from the group consisting of a Ravigneaux gearset, a Simpson gearset, a plurality of simple gearsets, and a six speed arrangement. The gear set device includes a first plurality of gear ratios and the planetary gear set is configured to augment the first plurality of gear ratios by adding at least one first gear ratio to the first plurality of gear ratios. In some aspects, the planetary gear set is configured to double the number of gear ratios.

In some aspects, the planetary gear set and the gear set device are configured to generate an upshift plurality of gear ratios when the gear set device operates in an upshift mode and a downshift plurality of gear ratios when the gear set device operates in a downshift mode. In some aspects, the first plurality of gear ratios is different than each of the upshift and downshift pluralities of gear ratios and the upshift plurality of gear ratios is different than the downshift plurality of gear ratios.

In some aspects, the planetary gear set includes a first clutch configured to transmit the torsional output for an engine to the gear set device during a first launch event for the vehicle. In some aspects, the system includes a second plurality of gear ratios and the first clutch is configured to establish a second gear ratio from among the second plurality of gear ratios. In some aspects, the system includes a third plurality of gear ratios and the planetary gear set includes a second clutch configured to establish a third gear ratio from among the third plurality of gear ratios.

The present invention broadly comprises a combination launch and torque transmission system for a vehicle with a launch clutch element in a rotating housing and a gear set device in a stationary housing. The clutch element has an input arranged for connection to a torsional output for an engine and the gear set device has an input connected to an output of the clutch element. The launch clutch element is configured to transfer the torsional output for an engine to the gear set device during a first launch event for the vehicle. In some aspects, the at least one gear set device is a planetary transmission.

The present invention further comprises respective methods for optimizing gear ratios in a combination torque transmission system and launching a vehicle.

It is a general object of the present invention to provide a system for augmenting the gear ratios available from a PAT in a stationary housing.

It is another object of the present invention to provide frictional launch capabilities to a PAT in a stationary housing.

It is yet a further object of the present invention to provide respective methods for optimizing gear ratios in a combination torque transmission system and launching a vehicle.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic representation of a present invention combination torque transmission system with a configuration of simple gearsets;

FIG. 2 is a graph illustrating gears and gear ratios according to the present invention;

FIG. 3 is a schematic representation of a present invention combination torque transmission system with a Simpson gearset;

FIG. 4 is a schematic representation of a present invention combination torque transmission system with a Ravigneaux gearset;

FIG. 5 is a schematic representation of a present invention combination torque transmission system with a Lepelletier six speed arrangement; and,

FIG. 6 is a schematic representation of a present invention combination launch and torque conversion system.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

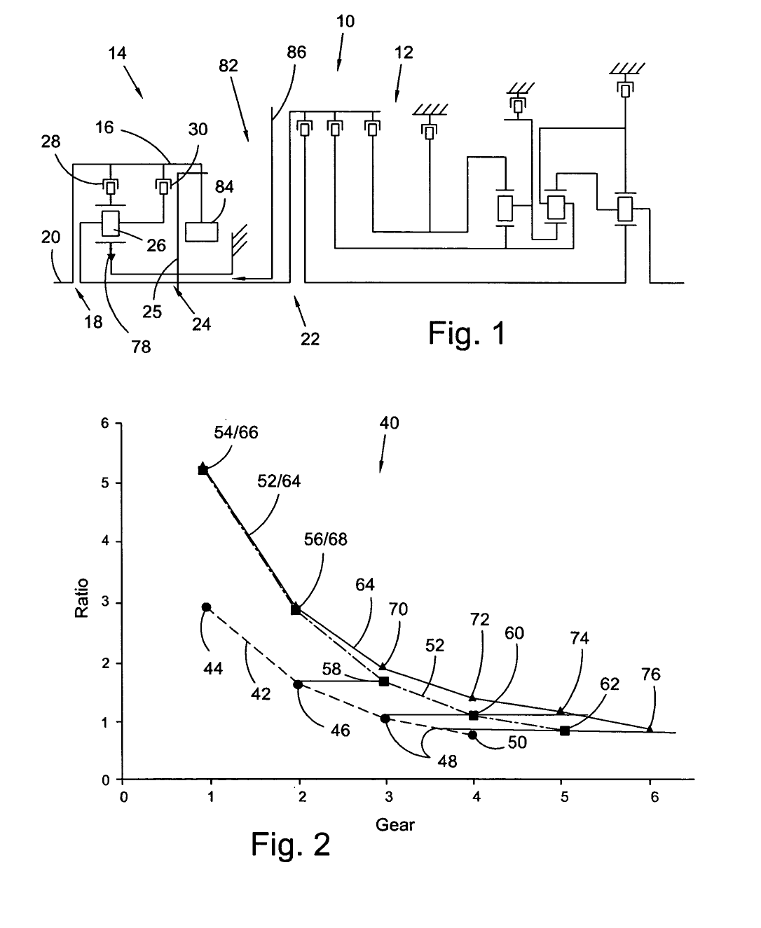

FIG. 1 is a schematic representation of present invention combination torque transmission system 10 with a configuration of simple gearsets 12. In FIG. 1, a configuration of simple gearsets is shown for gear set device 12. However, it should be understood that any gearset known in the art can be used in device 12. Other types of gearsets sets for device 12 are described infra. In some aspects, device 12 is a planetary transmission. System 10 includes planetary gear set 14 in rotating housing 16. Gear set 14 includes an input 18 arranged for connection to a torsional output device 20, for example, a crankshaft, for an engine (not shown). In FIG. 1, the input is connected to device 20. Input 22 of device 12 is connected to output 24 of planetary gear set 14. Device 12 includes stationary housing 25.

In some aspects, gear set 14 includes simple planetary set 26 and clutches 28 and 30. It should be understood that gear set 14 is not limited to the configuration and components shown in FIG. 1. Any combination of planetary gears and clutches in a rotating housing known in the art can be used for gear set 14. One possible configuration for gear set 14 is described in U.S. Provisional Application No. 60/707,226 “Geared Torque Converter with Multi-Plate Clutches and Planetary Gearset,” filed Aug. 10, 2005 and incorporated by reference herein.

FIG. 2 is a graph illustrating gears and gear ratios according to the present invention. Gear set device 12 is configured to generate or provide a plurality of gear and associated gear ratios (hereinafter referred to as original gear and gear ratios). The combination of simple gearsets shown in FIG. 1 has four original gears and gear ratios. However, it should be understood that the present invention is not limited to a particular number of original gears in device 12. In some aspects, set 14 is configured to transfer the torsional input through to device 12 (hereinafter referred to as the pass-through mode). That is, set 26 operates in a 1:1 ratio and clutch 30 is used to connect set 26 to output 24. In some aspects, set 14 is used to augment the plurality of gear ratios for device 12. That is, device 12 and set 14 in combination generate more ratios than can be generated by device 12 alone. Specifically, clutch 28 is used to engage set 26 to produce a ratio of other than 1:1 for set 14 (hereinafter referred to as the shift mode). The shift mode is used in combination with the original gears for device 12 to create at least one more gear and gear ratio than is available from device 12 otherwise. Using clutch 28 and set 26 in set 14, each original gear and gear ratio can be changed. That is, the number of gears and gear ratios in device 12 can be doubled. In general, the present invention generates from one additional up to double the number of gear ratios inherent in device 12.

In FIG. 2, the shift mode of set 14 generates a higher gear ratio for set 14. However, it should be understood that set 14 could be used in an “overdrive” configuration to create a lower gear ratio. In graph 40, line 42 shows gear ratios 44, 46, 48, and 50, for original gears one through four, respectively, of device 12. The preceding ratios are the ratios produced by device 12 when used without the augmentation provided by set 14. Line 52 shows a first strategy for using system 10 to augment the gears and gear ratios for device 12: adding a single additional gear, in this case, a first/launch gear with ratio 54. Specifically, clutch 28 is operated in the shift mode to produce a ratio >1:1 for set 14 and device 12 is operated in the original first gear. However, due to the ratio change in set 14, the ratio for the original first gear changes from 44 to 54. That is, a higher gear ratio is generated. Then, for the remaining gear shifts of device 12, set 14 operates in the pass-through mode and the ratios for the subsequent second through fifth gears are the same as the ratios for the original first through fourth gears. Thus, the first strategy provides a total of five gears with gear ratios 56, 58, 60, and 62 for second through fifth gears, and the previously mentioned gear ratio 54. Note that the additional gear could be added at any point in the shift sequence, for example (not shown), set 14 could be operated in the pass-through mode only for the original first gear and in the shift mode for one of the original second through fourth gears for device 12.

Line 64 shows a second strategy for using system 10 to augment the gears and gear ratios for device 12, namely, multiplying the original gears in device 12 by using the shift mode for set 14 with more than one of the original gear in device 12. This second strategy can, at a maximum, double the number of gears and gear ratios for device 12. Thus, the pass-through and shift modes of device 14 can be used with all the original gears in device 12. However, in the example of graph 40, line 64, only six gears, and associated ratios 66, 68, 70, 72, 74, and 76 are generated by this second strategy. Like the first strategy, the second strategy generates a launch gear with ratio 66 and then uses the pass-through mode to generate a second gear with ratio 68. However, the second strategy creates third and fourth gears with new ratios 70 and 72 by using the shift mode with the original second and third gears. Finally, the pass-through mode is used with the original third and fourth gears to produce new fifth and sixth gears with ratios 74 and 76.

Lines 42, 52, and 64 all end with a gear ratio of about 0.7:1 (overdrive). However, the strategies described above and shown on lines 52 and 64 generate more favorable gear ratios than are associated with device 12 alone. As described supra, an engine operates most efficiently at a certain rotational speed. The increase in the number of gear ratios available in a torque transmission system as provided by the present invention enables an engine providing the torque to operate closer to the optimal speed for longer periods of time. For example, at launch, both strategies provide a first gear with a more favorable ratio of about 5:1, in comparison to the ratio of about 3:1 for device 12 alone. The higher ratio enables a smoother and more efficient launch of the vehicle. In like fashion, the two strategies produce better ratios for the remaining gears on lines 52 and 64. Clutches 28 and 30 are used to engage and disengage planetary gear 26 to produce the gear augmentation described supra. Alternately stated, system 10 includes a plurality of system gear ratios. That is, gear ratios generated by combining the respective ratios of set 12 and device 14. For example, the respective groups of ratios shown on lines 52 and 64. Clutches 28 or 30 are used to establish a gear ratio from among the plurality of system gear ratios. It should be understood that other numbers and combinations of gears and gear ratios are possible and that such numbers and combinations are included in the spirit and scope of the invention as claimed.

In some aspects, system 10 is configured to generate one plurality of gear ratios when gear set device 12 operates in an up shift mode and another plurality of gear ratios when gear set device 12 operates in a downshift mode. In some aspects, the same ratios, for example, the ratios shown on line 52, are used for both up shifting and down shifting. In some aspects, different ratios are used for up shifting and down shifting. For example, the gear ratios shown on line 52 could be use to up shift and the ratio shown on line 64 could be used to down shift.

Set 12 includes one-way clutch 78, which can advantageously replace the multiple one-way clutches normally used in a planetary transmission, such as device 12. In some aspects, clutch 30 is configured as a launch clutch. That is, for a launch event for the vehicle in which system 10 is housed, the launch clutch is used to frictionally engage the torsional input from the engine with device 14. This arrangement advantageously eliminates the use of a torque converter (not shown) to launch the vehicle. As described supra, by eliminating the use of a torque converter for launch events, the weight, inertia, and losses associated with the converter are reduced.

Rotating housing 16 and stationary housing 25 are in fluid communication. For example, the housings can share a common cooling fluid sump (not shown). Pump 84 is located in device 12. Any pump known in the art can be used for pump 84. In some aspects, rotary housing 16 is arranged to cool the fluid. In particular, the rotary motion associated with the housing is used to cool the fluid. Examples of fluid cooling in housing 25 are described in U.S. Provisional Application No. 60/707,226. In some aspects, set 16 is configured to provide a high flow, low pressure stream 86 to cool clutches 28 and 30. In general, high flow, low pressure cooling circuits are preferred for clutch applications. However, typically an automatic transmission operates with low flow, high pressure cooling circuits. That is, pump 84 typically cannot provide the cooling circuit needed for a launch clutch.

Clutch cooling is improved in system 10 because the rotation of housing 16 is used to move cooling fluid through the clutches. This cooling flow is possible because fluid within the housing rotates with the housing. In this manner, the fluid gathers kinetic energy and static pressure in response to centrifugal forces generated by the rotation of housing 16. These forces can be used with pipes, blades, or grooves (not shown) to move fluid rapidly through clutch friction interfaces (not shown), thereby removing heat from the clutch. The mass of the fluid in housing 16, together with the mass of the housing 16, acts as a heat sink for the energy (heat) produced by the clutch. The heat sink is cooled over time by the flow of the fluid through system 10. It is very difficult to achieve the type of heat transfer described supra when a clutch is located in a stationary housing.

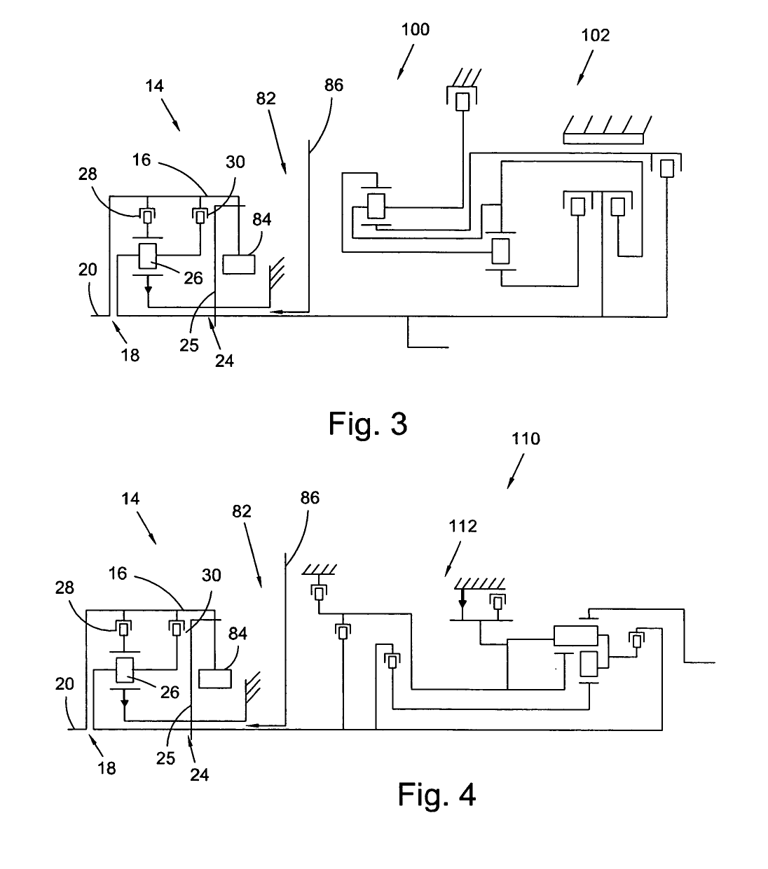

FIG. 3 is a schematic representation of present invention combination transmission system 100 with Simpson gearset 102.

FIG. 4 is a schematic representation of present invention combination torque transmission system 110 with Ravigneaux gearset 112.

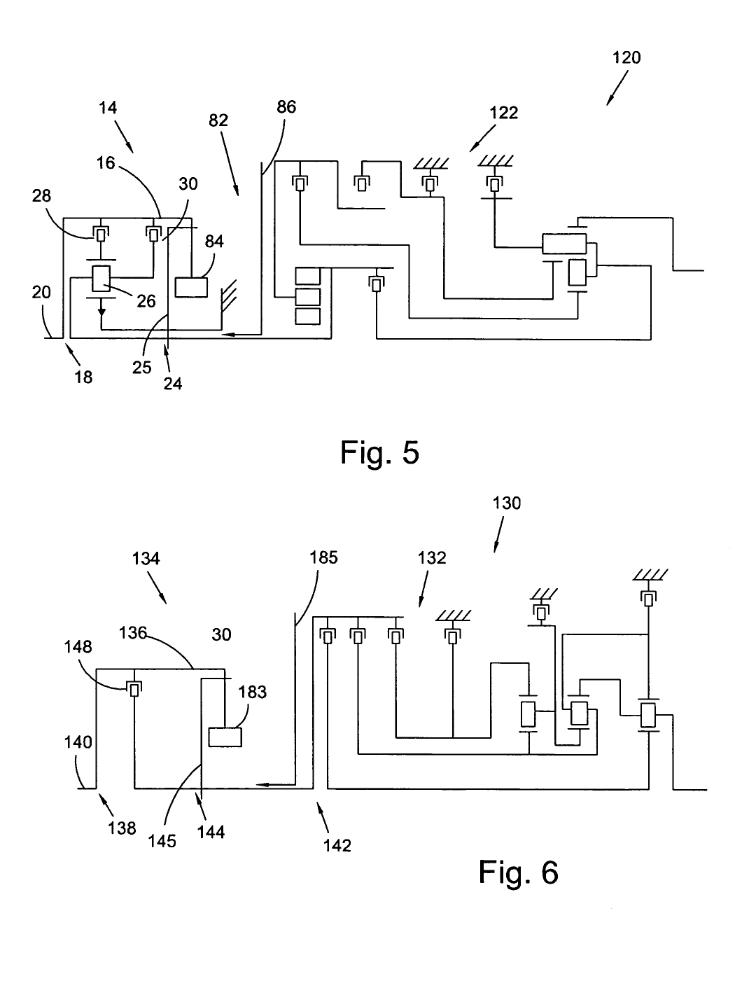

FIG. 5 is a schematic representation of present invention combination torque transmission system 120 with Lepelletier six speed arrangement 122. The following should be viewed in light of FIGS. 1 through 5. FIGS. 3 through 5 illustrate other possible configurations for device 12. It should be understood that the present invention is not limited to the configurations for devices 12, 102, 112, or 122, shown in the figures and that other possible configurations are included in the spirit and scope of the invention as claimed. For example, other numbers of simple gearsets can be used in configuration 112. Also, arrangements with other numbers of speeds can be used.

In general, the discussion regarding gears and gear ratios in the descriptions for FIGS. 1 and 2 is applicable to FIGS. 3 through 5. However, depending on the number of gear ratios inherent in devices 102, 112, and 122, respectively, differing numbers of gear ratios can be generated by augmenting these inherent gear ratios with set 14. For example, since 112 in FIG. 5 has six gears, applying the first strategy noted supra adds an additional gear and gear ratio (not shown), resulting in seven gears and attendant gear ratios, rather than the five gears and gear ratios shown for line 52 in graph 50 of FIG. 2. The discussion regarding cooling, pump 84, and steam 86 in the description for FIG. 1 is applicable to FIGS. 3 through 5. Although pump 84 and stream 86 are shown in each of FIGS. 3 through 5, it should be understood that the pump and stream can be modified as required or desired in accordance with the particular planetary transmission in use and the requirements of system 100, 110, or 120, respectively.

FIG. 6 is a schematic representation of present invention combination launch and torque transmission system 130 with gear set device 132. In FIG. 6, a configuration of simple gearsets is shown, however, any of the gear set devices shown or discussed in the descriptions for these figures can be used in system 130. System 130 includes launch clutch device 134 in rotating housing 136. Element 134 includes an input 138 arranged for connection to a torsional output 140 for an engine (not shown). Input 142 of device 132 is connected to output 144 of element 134. Device 132 includes stationary housing 145.

Element 134 includes clutch 148. It should be understood that element 134 is not limited to the configuration and components shown in FIG. 6. Any combination of clutches in a rotating housing known in the art can be used for gear set 134. Clutch 148 is configured as a launch clutch. That is, for a launch event for the vehicle in which system 130 is housed, the launch clutch is used to frictionally engage the torsional input from the engine with device 134. This arrangement eliminates the use of a torque converter (not shown) to launch the vehicle. As described supra, by eliminating the use of a torque converter for launch events, the weight, inertia, and losses associated with the converter are reduced.

System 130 includes pump 183 and stream 185. In some aspects, rotating housing 136 and stationary housing 145 are in fluid communication. The discussion regarding cooling, pump 84, and steam 86 in the description for FIG. 1 is applicable to system 130, specifically, pump 183, and stream 185, respectively, in FIG. 6.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A combination torque transmission system for a vehicle, comprising:
a planetary gear set in a rotating housing, said gear set with an input arranged for connection to a torsional output for an engine;
a gear set device in a stationary housing, where said gear set device includes an input connected to an output of said planetary gear set.

2. The system of claim 1 wherein said at least one gear set device is a planetary transmission.

3. The system of claim 2 wherein said planetary transmission is selected from the group consisting of a Ravigneaux gearset, a Simpson gearset, a plurality of simple gearsets, and a Lepelletier six speed arrangement.

4. The system of claim 1 wherein said gear set device further comprises a first plurality of gear ratios and said planetary gear set is configured to augment said first plurality of gear ratios.

5. The system of claim 4 wherein said planetary gear set is configured to augment said first plurality of gear ratios by adding at least one first gear ratio to said first plurality of gear ratios.

6. The system of claim 4 wherein said first plurality of gear ratios comprises a first number of gear ratios and said planetary gear set is configured to double said first number of gear ratios.

7. The system of claim 4 wherein said planetary gear set and said gear set device are configured to generate an upshift plurality of gear ratios when said gear set device operates in an upshift mode and a downshift plurality of gear ratios when said gear set device operates in a downshift mode.

8. The system of claim 7 wherein said first plurality of gear ratios is different than each of said upshift and downshift pluralities of gear ratios and said upshift plurality of gear ratios is different than said downshift plurality of gear ratios.

9. The system of claim 1 wherein said planetary gear set further comprises a first clutch configured to transmit said torsional output for an engine to said gear set device during a first launch event for said vehicle.

10. The system of claim 9 further comprising: a second plurality of gear ratios; and, wherein said first clutch is configured to establish a second gear ratio from among said second plurality of gear ratios.

11. The system of claim 1 further comprising: a third plurality of gear ratios; and, wherein said planetary gear set further comprises a second clutch configured to establish a third gear ratio from among said third plurality of gear ratios.

12. The system of claim 1 wherein said planetary gear set further comprises a one-way clutch arranged to prevent torque reversal in said gear set device.

13. The system of claim 1 wherein said rotating housing and said stationary housing are in fluid communication.

14. A combination launch and torque transmission system for a vehicle, comprising:
a launch clutch element in a rotating housing, said clutch element with an input arranged for connection to a torsional output for an engine;
a gear set device in a stationary housing, said gear set device with an input connected to an output of said clutch element, where said launch clutch element is configured to transfer said torsional output for an engine to said gear set device during a first launch event for said vehicle.

15. The system of claim 14 wherein said rotating housing and said stationary housing are in fluid communication.

16. The system of claim 14 wherein said at least one gear set device is a planetary transmission.

17. A method for optimizing gear ratios in a combination torque transmission system, comprising:
supplying a torsional output for an engine to an input for a planetary gear set in a first housing;
operating said planetary gear set to generate a first plurality of rotational ratios between said input for said planetary gear set and an output for said planetary gear set;
providing said output of said planetary gear set to an input of a planetary transmission, said planetary transmission disposed in a second housing separate from said first housing and said planetary transmission configured to provide a second plurality of rotational ratios between said input for said planetary transmission and an output for said planetary transmission; and,
operating said planetary transmission to add at least one more rotational ratio to said second plurality of rotational ratios.

18. The method of claim 17 wherein said second plurality comprises a first number of gear ratios and operating said planetary transmission further comprises doubling said first number of gear ratios.

19. The method of claim 17 wherein said planetary transmission is selected from the group consisting of a Ravigneaux gearset, a Simpson gearset, a plurality of simple gearsets, and a Lepelletier six speed arrangement.

20. The method of claim 17 further comprising:
upshifting said planetary transmission and operating said planetary gear set to generate an upshift plurality of gear ratios; and,
downshifting said planetary transmission and operating said planetary gear set to generate a downshift plurality of gear ratio, said upshift plurality of gear ratios different than said downshift plurality of gear ratios.

21. The method of claim 17 wherein said planetary gear set comprises a first clutch; and, said method further comprising: operating said first clutch to establish a first gear ratio from among said second plurality of rotational ratios with said at least one more rotational ratio added.

22. The method of claim 17 further comprising:
blocking, in said planetary gear set, torque reversal of said input for said planetary transmission.

23. The method of claim 17 further comprising: rotating said first housing.

24. A method for launching a vehicle, comprising:
generating engine torque to launch said vehicle;
supplying said engine torque to an input for a launch clutch in a first housing;
connecting an output of said launch clutch to an input of a planetary transmission, said planetary transmission disposed in a second housing separate from said first housing; and,
operating said launch clutch to transfer said engine torque to said planetary transmission.

25. The method of claim 24 further comprising: rotating said first housing.

26. The method of claim 24 wherein said planetary transmission is selected from the group consisting of a Ravigneaux gearset, a Simpson gearset, a plurality of simple gearsets, and a Lepelletier six speed arrangement.
